(19) United States
(12) Patent Application Publication
(10) Pub. No.: US 2025/0206053 A1
(43) Pub. Date: Jun. 26, 2025

(54) SYSTEM AND METHOD FOR AUTOMATED CREATION OF ARTWORKS

(71) Applicant: PATRICE BADAMI, New City, NY (US)

(72) Inventor: PATRICE BADAMI, New City, NY (US)

(21) Appl. No.: 18/972,936

(22) Filed: Dec. 7, 2024

Related U.S. Application Data
(60) Provisional application No. 63/613,137, filed on Dec. 21, 2023.

(51) Int. Cl. B41M 5/025; B25J 11/00; B41J 2/005; B41J 2/01; B41J 2/21; B41J 3/44; B41J 11/00; B41J 29/00; B41M 5/00; B41M 5/03; B41M 7/00

(52) U.S. Cl. CPC B41M 5/0256; B25J 11/0075; B41J 2/0057; B41J 2/2121; B41J 3/44; B41J 11/00214; B41J 11/00216; B41J 29/00; B41M 5/0011; B41M 5/0047; B41M 5/03; B41M 7/0036; B41M 7/0081; B41J 2002/012; B41M 2205/10

(57) ABSTRACT

The present disclosure provides a system for automated creation of artwork. The system comprises a processing unit to receive a digital design input, a temperature-controlled platform with a milk container to maintain a milk composition at a predetermined temperature, a revolving turret mechanism with multiple dispensing nozzles for different food-grade dyes and a detergent-dispensing mechanism to selectively deposit detergent after the dye. The revolving turret positions required dispensing nozzle to deposit food-grade dye onto the milk composition based on the design input. The detergent interacts with the dye to create an intrinsic color pattern on the milk surface. An automated transfer mechanism positions a photo paper sheet onto the milk composition to transfer the color pattern onto the photo paper and create the artwork.

### CROSS-REFERENCE TO RELATED APPLICATIONS/INCORPORATION BY REFERENCE

This application claims priority to U.S. provisional application 63/613,137 titled “METHOD FOR GENERATING WATERCOLOR ARTWORK” filed on Dec. 21, 2023, which is incorporated herein by reference in its entirety for all purposes.

### FIELD OF THE INVENTION

The present disclosure generally relates to automated systems for creating visual art. Further, the present disclosure particularly relates to a system for automated creation of artwork on a milk-based medium with food-grade dyes and detergents. Moreover, the present disclosure relates to a method for automated creation of artworks.

### BACKGROUND

The description in the Background section includes general information related to the field of the present application. The background is only meant to provide context to a reader in understanding the present invention. It is neither to be taken as an admission that any of the information provided relates to prior art for the presently claimed invention nor that any publication explicitly or implicitly referenced within this section relates to prior art. The background section is merely meant to be illustrative rather than exhaustive and is primarily intended to identify problems associated with the present state of the art.

Generally, artistic creation serves as a vital medium for expression, encompassing various traditional techniques such as painting and drawing. However, such methods often require significant skill and practice. Further, acquiring proficiency in artistic creation involves mastering complex elements such as composition, color theory and perspective, which can be Intimidating for beginners. Additionally, traditional methods demand high-quality materials, such as specific paints and paper, which may not be accessible to all aspiring artists.

Traditionally, techniques involving liquid media, such as marbling, offer a more accessible approach to creating unique patterns without extensive skill. The marbling technique involves floating paint on a liquid medium to form intricate designs. However, managing the Interaction of colors can be challenging and the quality of the materials, including the liquid medium and paints, greatly affects the outcome, making the process less predictable.

Therefore, there is a need for solutions that simplify the artistic process, reduce reliance on advanced skills and provide consistent results. Such solutions would enable a broader range of individuals to engage in artistic creation.

### SUMMARY

The following Summary section provides only a brief introduction to the various embodiments of the present invention. It is to be understood that the following paragraphs are neither meant to constitute a complete and thorough description of the claimed subject matter nor is it intended to define the technical features or the scope of the claimed subject matter. Thus, the description in the Summary section is neither intended to identify only the essential features of the present invention nor limit the scope of the claimed subject in any manner.

In an aspect, the present disclosure provides a system for automated creation of an artwork. The system comprises a processing unit configured to receive a digital design input and a temperature-controlled platform comprising a milk container to hold a milk composition. The temperature-controlled platform maintains the milk composition at a predetermined temperature. Further, the system comprises a revolving turret mechanism comprising a plurality of dispensing nozzles. Each dispensing nozzle corresponds to a different food-grade dye. The revolving turret mechanism is configured to rotate to position a required dispensing nozzle over the milk container to deposit at least one food-grade dye onto the milk composition based on the received digital design input. The system also comprises a detergent-dispensing mechanism configured to selectively deposit at least one detergent onto the milk composition after the dye has been deposited to enable creation of an intrinsic color pattern on the surface of the milk composition. Additionally, the system comprises an automated transfer mechanism configured to position a photo paper sheet onto the milk composition in a controlled manner to transfer the created intrinsic color pattern onto the photo paper to create the artwork. The system automates and enhances precision in the creation of intricate artwork, significantly reducing manual intervention.

In an embodiment, the system comprises a biaxial arm operatively connected to the processing unit to move the revolving turret mechanism over the milk container. The biaxial arm is controlled by the processing unit to position each required dispensing nozzle at specified coordinates based on the digital design input. The configuration of the biaxial arm ensures precise and targeted dye application, enabling Intricate and consistent pattern formation.

In another embodiment, each dispensing nozzle of the revolving turret mechanism comprises a variable droplet dispenser configured to adjust both the droplet size, and the pattern of the food-grade dye deposited onto the surface of the milk composition. The variable droplet dispenser allows for customization of details of the artwork, enhancing visual complexity and precision.

In yet another embodiment, the detergent-dispensing mechanism comprises a selectable applicator for depositing the detergent onto the milk composition. The selectable applicator is selected from a jet spray, a droplet dispenser and a swab-based applicator. The selectable applicator enables diverse pattern effects by manipulating detergent-dye interactions.

In still another embodiment, the system further comprises an agitation arm operatively connected to the processing unit and configured to interact with selected portions of the milk composition. The agitation arm comprises a soft-tip actuator configured to modify the created Intrinsic color pattern. The soft-tip actuator facilitates dynamic adjustments, allowing for real-time pattern customization.

In a further embodiment, the automated transfer mechanism is configured to perform a surface modification of the photo paper sheet prior to positioning the photo paper sheet onto the milk composition. The surface modification improves adhesion and clarity of the transferred artwork, enhancing final quality thereof.

In another embodiment, the system includes a drying station configured to receive the photo paper sheet after transfer of the created Intrinsic color pattern. The drying station ensures proper setting of the artwork, reducing smudging and preserving the design integrity.

In yet another embodiment, the system comprises a light source positioned adjacent to the milk container to selectively dry specific portions of the artwork transferred onto the photo paper sheet. The light source is selected from an ultraviolet (UV) emitter or an infrared (IR) emitter. The light source enables controlled drying, enhancing detail preservation and texture.

In still another embodiment, the system Includes a feedback unit comprising a high-resolution camera configured to monitor the evolution of the artwork on the milk composition. The feedback unit communicates real-time data to the processing unit for real-time adjustments in the deposition of the food-grade dye and detergent. The feedback unit ensures continuous quality control and adaptive corrections, enhancing the overall accuracy of the artwork.

In a further embodiment, the system includes a vibration mechanism configured to impart controlled vibratory motion to the milk composition to produce minor dispersion of the deposited food-grade dye without disrupting the artwork pattern. The vibration mechanism adds subtle variations, enhancing the aesthetic appeal of the patterns.

In another embodiment, the system comprises a tilting mechanism configured to apply a controlled tilt to the milk container to adjust the angle of the milk composition, thereby directing the flow of the deposited food-grade dye and detergent. The tilting mechanism provides directional control over pattern flow, allowing for unique artistic effects.

In a second aspect of the invention, the present disclosure provides a method for automated creation of an artwork. The method comprises receiving a digital design input via the processing unit, maintaining the milk composition at a predetermined temperature within the temperature-controlled platform comprising the milk container, rotating the revolving turret mechanism to select and position a dispensing nozzle corresponding to the food-grade dye over the milk composition, depositing at least one food-grade dye based on the digital design input, selectively depositing at least one detergent onto the milk composition after the dye has been deposited to enable interaction of the detergent with the dye and positioning the photo paper sheet onto the milk composition in a controlled manner using the automated transfer mechanism to transfer the created pattern onto the photo paper sheet. The method streamlines the artistic process, ensuring high consistency and repeatability in creating detailed artwork.

In an embodiment, the method further comprises adjusting the transferred pattern on the photo paper sheet before drying. The adjustment of the pattern allows fine-tuning the artwork post-transfer, ensuring optimal final appearance.

In another embodiment, the method comprises drying the photo paper sheet after transferring the intrinsic color pattern. The drying process ensures the artwork is preserved and durable, enhancing longevity thereof.

In yet another embodiment, the method includes scanning the photo paper sheet to generate a digital version of the artwork. The scanning process enables easy replication and sharing of the artwork, expanding its usability across digital platforms.

The various objects, features, and advantages of the claimed invention will become clear when reading the following Detailed Description along with the Drawings.

### BRIEF DESCRIPTION OF THE DRAWINGS

The following Brief Description of Drawings section will be better understood when read in conjunction with the appended drawings. Although exemplary embodiments of the present invention are illustrated in the drawings, the embodiments are not limited to the specific features shown in the drawings. The drawings illustrate simplified views of the claimed invention and are therefore, not made to scale. Identical numbers in the drawings indicate like elements in the drawings.

The embodiments of the present invention will now be briefly described by way of example only with reference to the drawings in which:

FIG. 1 shows a schematic illustration of a system for automated creation of an artwork, in accordance with an embodiment of the present disclosure;

FIG. 2 shows a flowchart illustrating steps of a method for automated creation of an artwork, in accordance with an embodiment of the present disclosure;

FIGS. 3A-F shows steps of creating an artwork using the method for automated creation of the artwork, in accordance with an embodiment of the present disclosure;

FIGS. 4A-F show artworks created using a system for automated creation of an artwork (such as the system of FIG. 1), in accordance with an embodiment of the present disclosure; and

FIG. 5 shows steps of manually creating an artwork using a method for automated creation of the artwork, in accordance with an embodiment of the present disclosure.

### DETAILED DESCRIPTION

The following is a detailed description of exemplary embodiments to illustrate the principles of the invention. The embodiments are provided to illustrate aspects of the invention, but the invention is not limited to any single embodiment. The scope of the invention encompasses without limitation numerous alternatives, modifications and combinations.

It shall be noted that as used within the current section as well as in the appended claims, the singular forms “a”, “an”, and “the” include plural referents unless the context clearly dictates otherwise. Further, the use of words such as “first”, “second”, “third” and the like does not represent any particular order. Such words have been merely employed to distinguish one individual component from another. Moreover, “each” refers to each member of a set or each member of a subset of a set.

As used herein, the term “processing unit” refers to a component of the system configured to receive and interpret digital design input related to creation of an artwork. Such a processing unit may comprise various types of computing systems such as microcontrollers, embedded processors or general-purpose processors capable of executing code to process digital data. The processing unit is configured to analyze digital design input, which may comprise preferred color, size, pattern, pixel-based data, vector graphics or other encoded patterns representing the desired artwork. The processing unit analyzes the received input data to manage various mechanisms in a coordinated manner to create the artwork. Examples of processing units include single-board computers such as Raspberry Pi, microcontroller units such as Arduino or more robust processing environments provided by FPGA-based setups.

As used herein, the term “temperature-controlled platform” refers to a substrate designed to maintain a stable, predefined temperature for a milk container holding milk composition. Such a platform may be equipped with heating elements such as resistive heaters or Peltier coolers, depending on the temperature requirements of the milk composition. The platform enables the milk composition to remain in a suitable state by regulating the temperature thereof for dye deposition and interaction with detergent agents. Optionally, temperature-sensing components such as thermocouples, thermistors or infrared sensors can be incorporated into the platform to enable feedback control for precise temperature management and prevention of curdling or premature setting of the milk.

As used herein, the term “revolving turret mechanism” refers to a rotating apparatus that houses multiple dispensing nozzles, such as, each nozzle is associated with a distinct food-grade dye. The revolving turret mechanism enables orientation of a specific dispensing nozzle over the milk container based on instructions from the processing unit, allowing the targeted deposition of dyes. The revolving turret mechanism may comprise components such as a motorized rotary base, controlled by servos or stepper motors, that enables precision positioning of the nozzles. Additionally, each dispensing nozzle may be connected to an individual dye reservoir, allowing independent control of dye release. For example, the revolving turret mechanisms is incorporated as rotary systems used in automated dispensers or robotic arms in painting or 3D printing applications, configured for selective material application based on design parameters.

As used herein, the term “dispensing nozzle” refers to a component that enables controlled deposition of food-grade dyes onto the milk composition in accordance with digital design instructions. Each nozzle may incorporate a pressure-regulated system to manage the flow rate, pattern and amount of dye, enabling consistent dye placement. Further, the nozzle may be selected from capillary nozzles, microfluidic valves or syringe-based dispensers, such that the selection is based on dye viscosity and patterning requirement. Optionally, the nozzle may be fitted with a solenoid or piezoelectric actuator for precise control for a seamless transition between colors during design formation.

As used herein, the term “detergent-dispensing mechanism” refers to a component configured to deposit a detergent onto the milk composition post dye application, enabling the formation of distinct color patterns. Such a mechanism may employ controlled-release techniques, where a small volume of the detergent is added at targeted locations on the milk surface and/or deposited dye, causing the reaction of the detergent with the dye and/or milk to form characteristic fluid patterns through a chemical reaction with milk fats/protein. The detergent-dispensing mechanisms may comprise spray nozzles, micro-pipettes or drop-on-demand dispensers, such that each one is chosen to control the detergent volume accurately. The detergent may be selected from mild liquid soap solutions, typically used to interact with milk to create visually dynamic reactions due to surface tension disruptions.

As used herein, the term “automated transfer mechanism” refers to a mechanism designed to place a photo paper sheet onto the milk composition to capture the created color pattern in a controlled manner. said the automated transfer mechanism may comprise components such as robotic arms, gantry systems or spring-loaded platforms to gently lower the photo paper onto the milk without disrupting the created color pattern. Optionally, sensors, such as proximity or touch sensors, may be integrated into such a mechanism to monitor positioning accuracy, ensuring the paper contacts the milk surface uniformly. For example, the automated transfer mechanism is implemented using automated transfer systems similar to those used in screen printing or photo transfer applications. In such examples, precise placement and timing are essential to achieving a high-quality transfer of an intricate design.

As used herein, the term “biaxial arm” refers to a mechanical structure with two axes of movement, allowing for precise control of positioning across both the X and Y planes relative to the milk container. The biaxial arm is operatively connected to the processing unit, enabling controlled movement of the revolving turret mechanism to designated coordinates based on digital design input. The biaxial arm may include actuators, such as stepper motors or servos and is commonly guided by a set of linear rails or rotary joints, providing the range and precision needed for artwork creation. For example, the biaxial arm can be implemented using robotic arms used in 3D printing and CNC machining applications, where the control of toolhead positioning is essential for achieving detailed patterns.

As used herein, the term “variable droplet dispenser” refers to a component within each dispensing nozzle configured to control both the size and distribution pattern of dye droplets deposited onto the milk composition. Such a dispenser may comprise adjustable mechanisms, such as piezoelectric actuators or pneumatic pressure systems, allowing for dynamic control of droplet formation and ejection. The droplet size may vary from fine misting to larger, more concentrated drops, depending on the design input and the intended visual effect. For example, the dispenser can be implemented using dispensers used in inkjet printing or microfluidics that are capable of varying droplet size and pattern precisely to generate complex, layered artwork.

As used herein, the term “selectable applicator” refers to a component within the detergent-dispensing mechanism designed to enable various modes of detergent application. The applicator may comprise a jet spray for broad coverage, a droplet dispenser for precision application and a swab-based applicator for surface-specific interaction. Each applicator type serves a distinct purpose. For example, jet sprays allow for even dispersion across larger areas, droplet dispensers target small regions and swabs provide gentle contact with the surface of the milk. The selectable applicator can be implemented using applicators found in automated cleaning or coating systems, where each applicator type fulfills a specific function based on material interaction requirements.

As used herein, the term “agitation arm” refers to a flexible, controlled arm equipped with a soft-tip actuator to interact selectively with the milk composition, modifying sections of the created color pattern. The soft-tip actuator, which may be made from materials such as silicone or foam, provides gentle, non-disruptive interaction, allowing fine adjustments to the pattern without causing turbulence in the milk composition. The agitation arm can be implemented using soft robotic manipulators or stylus arms used in digital art systems for blending or shaping materials delicately.

As used herein, the term “surface modification” refers to any preparatory treatment applied to the photo paper sheet by the automated transfer mechanism prior to placement thereof on the milk composition. Such modification may comprise chemical treatments, such as coating with a bonding agent or physical alterations, such as texturing, which enhance the ability of the photo paper to capture the color pattern effectively. The surface modifications may be applied using methods such as spray coating, corona treatment or mechanical embossing, such that each method is selected to increase adhesion or visual clarity of the transferred artwork.

As used herein, the term “drying station” refers to a designated area or apparatus configured to receive the photo paper sheet post-transfer, facilitating the drying of the artwork to ensure stability and preservation of the color pattern. The station may employ air drying, thermal drying or UV curing to expedite the drying process, depending on the materials involved. The drying station can comprise conveyor-belt drying systems or UV curing chambers used in industrial printing, where controlled drying environments are critical for the stability of printed outputs.

As used herein, the term “light source” refers to a device positioned near the milk container to selectively dry specific portions of the artwork on the photo paper sheet by emitting either ultraviolet (UV) or infrared (IR) light. The UV light sources enable polymerization or curing of certain materials, while IR emitters provide localized heating to evaporate moisture, allowing for selective and controlled drying. Light sources with such targeted applications are common in precision drying, such as in spot curing of adhesives or the curing of ink in screen printing, providing the capability for exact drying of designated sections.

As used herein, the term “feedback unit” refers to an integrated system comprising a high-resolution camera configured to monitor the ongoing development of the artwork on the milk composition. The feedback unit captures real-time data, such as changes in dye dispersion or detergent reaction and relays the captured information to the processing unit for instant adjustments to deposition rates or patterning. Further, high-resolution imaging enables fine details to be tracked. The feedback unit can be implemented using similar systems employed in precision manufacturing or quality control processes where live monitoring and corrective actions are required.

As used herein, the term “vibration mechanism” refers to a device configured to impart controlled, low-intensity vibratory motion to the milk composition, enabling minor dispersion of the food-grade dye without disturbing the overall pattern. Such a mechanism may comprise components such as piezoelectric elements or miniature motorized platforms, each providing adjustable vibration frequencies and amplitudes. The vibration mechanism can be implemented using similar systems employed for ink diffusion in printing or delicate fluid manipulation in laboratory setups, where subtle movement enhances material interactions without overwhelming the composition.

As used herein, the term “tilting mechanism” refers to a system designed to apply a gradual tilt to the milk container, adjusting the angle of the milk composition to direct the flow of deposited dye and detergent. The controlled tilt enables gravity-assisted movement, allowing for complex gradients or transitions in color. For example, the tilting mechanism comprises motorized gimbals or hydraulic systems in art installations or fluid dynamics studies, where precise angle adjustments influence fluid movement and create visual effects based on controlled tilt dynamics.

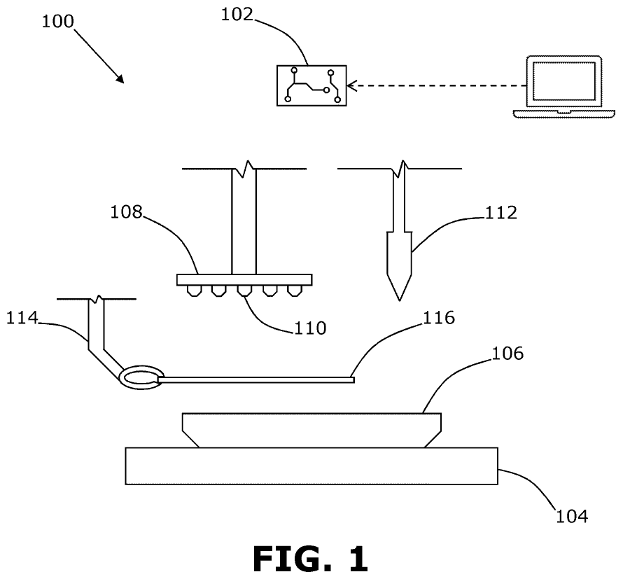

Referring to FIG. 1, there is shown a schematic illustration of a system 100 for automated creation of an artwork, in accordance with an embodiment of the present disclosure. The system 100 comprises a processing unit 102 configured to receive a digital design input. The processing unit 102 refers to a computing device or microcontroller that processes and interprets the digital design input provided by a user through an interface (such as a laptop computer, a personal computer or a smartphone) or uploaded from a storage device. The processing unit 102 translates the digital design input into specific instructions that control various components of the system 100, ensuring accurate recreation of the desired pattern on the milk composition. The precise translation of the digital design input into mechanical actions significantly reduces human error, enhances repeatability and ensures that complex designs can be rendered accurately, even by users with minimal artistic skill. The system 100 supports a broad range of design formats and resolutions by allowing digital design input from multiple sources. Further, users can also provide design input through graphical editing software or design applications, making it possible to create intricate visuals that might be challenging or impractical to replicate by hand. Moreover, design input provides high degrees of customization, making accessible to users with varied skill levels. It will be appreciated that in comparison to manual methods, where maintaining design consistency over multiple iterations can be a challenge, the digital design input enables uniformity across multiple outputs.

The system 100 further comprises a temperature-controlled platform 104 comprising a milk container 106 to hold a milk composition. The temperature-controlled platform 104 maintains the milk composition at a predetermined temperature. The temperature-controlled platform 104 ensures stability of the physical properties of the milk composition, such as viscosity and surface tension, which are critical for consistent dye dispersion and detergent interaction. The temperature-controlled platform 104 maintains a stable temperature, thereby preventing premature coagulation or rapid spreading of the food-grade dyes and enabling finer control over the pattern formation. The milk container 106 is constructed from materials such as stainless steel or high-grade plastic. Consequently, the milk container 106 provides durability and ease of cleaning while also being resistant to the food-grade dyes and detergents used in the process. The stability ensured by the temperature-controlled platform 104 provides uniform conditions for each artwork, thereby improving reproducibility of patterns across multiple uses. The platform 104 enables uniform dye dispersion across the milk surface by stabilizing milk composition properties. It will be appreciated that without such temperature control, the composition properties of the milk composition could fluctuate, leading to inconsistent dye behavior or unexpected interactions with the detergent, which may distort the artwork. For example, colder milk tends to be more viscous, impeding smooth dye dispersion, while warmer milk could lead to rapid thinning, where the dye may disperse too quickly, making pattern control challenging. The platform 104 mitigates such issues by maintaining the milk composition within an ideal temperature range, achieving a stable medium that facilitates consistent, reliable results. Further, in traditional processes, temperature variability introduces limitations, often requiring users to repeat the process multiple times to achieve the desired outcome. The temperature-controlled platform 104 overcomes such an issue by enabling consistent conditions that eliminate the need for repeated attempts due to environmental fluctuations. Thus, the temperature-controlled platform 104 saves time and resources and also improves the predictability of the artwork, enabling system 100 suitable for scaled-up or production-oriented contexts where reliability and efficiency is very critical. The system 100 also comprises a revolving turret mechanism 108 comprising a plurality of dispensing nozzles 110. Each dispensing nozzle 110 corresponds to a different food-grade dye. The revolving turret mechanism 108 is configured to rotate to position a required dispensing nozzle 110 over the milk container 106 to deposit at least one food-grade dye onto the milk composition based on the received digital design input. The precision of the revolving turret mechanism 108, driven by high-accuracy servomotors, allows for exact placement of food-grade dyes in specified locations. Such a capability facilitates creation of highly intricate patterns while also enables reproduction of complex designs accurately. The use of corrosion-resistant materials for the dispensing nozzles 110 ensures long-term reliability and compatibility with various dye formulations. Examples of food-grade dyes include natural dyes such as beet juice, turmeric and spirulina extract, as well as synthetic dyes such as FD&C Red No. 40 and Blue No. 1. The precise deposition of food-grade dyes allows for creation of vivid and distinct patterns, enhancing visual appeal and detail of the artwork.

The revolving turret mechanism 108 allows for a high degree of control over various aspects of the dye deposition, including but not limited to, rate, amount, pattern and angular position, all of which are critical to creating detailed, repeatable artwork. In traditional or manual color deposition processes, achieving such precision and control is difficult, especially when multiple colors are involved. For example, a manually applied dye may vary in concentration, leading to inconsistencies in color intensity or dispersal. Similarly, achieving specific patterns or transitioning smoothly between colors can be challenging without automated guidance, especially on a fluid surface like milk. The revolving turret mechanism 108 overcomes such limitations by allowing each dispensing nozzle 110 to deposit dye in a regulated and repeatable manner, enabling a consistent design outcome across multiple applications. The revolving turret mechanism 108 enables dyes to be applied precisely according to the design input by enabling the controlled rotation and positioning of each nozzle 110, such as, to prevent blending or smudging of colors, which are common issues in manual applications. Additionally, the ability of revolving turret mechanism 108 to adjust parameters such as the angle and positioning of each nozzle allows for highly specific patterning effects. For example, by angling the nozzle 110 slightly, the turret mechanism 108 can create shadowing or gradient effects, which add depth to the artwork and enhance its visual appeal. Thus, the revolving turret mechanism 108 represents a significant improvement over traditional artwork creation. Further, the revolving turret mechanism 108 addresses limitation of manual color deposition challenges such as hand pressure, speed and angle by standardizing color application process.

Moreover, the system 100 comprises a detergent-dispensing mechanism 112 configured to selectively deposit at least one detergent onto the milk composition after the food-grade dye has been deposited to enable creation of an intrinsic color pattern on a surface of the milk composition. The detergent-dispensing mechanism 112 comprises a controlled dispensing system, such as a pump or solenoid valve, which ensures precise application of detergent in calculated amounts. The detergent interacts with the surface tension of the milk composition, disrupting the surface tension and causing the food-grade dyes to spread in controlled and dynamic patterns. Such interaction results in formation of complex and fluid designs that can be manipulated further by varying the detergent application. Suitable detergents include biodegradable dishwashing liquids or surfactants like sodium lauryl sulfate, which are selected for their ability to create pronounced reactions without leaving harmful residues. The ability to selectively apply detergent allows for tailored manipulation of patterns, offering users enhanced creative control over the artwork.

It will be appreciated that unlike manual application methods, where the deposition of detergent can be inconsistent in terms of rate, amount and position, the detergent-dispensing mechanism 112 provides enhanced control over such parameters, resulting in a repeatable and refined artistic effect. The detergent-dispensing mechanism 112 offers control over critical factors such as the rate of detergent release, the amount of detergent dispensed and the angular position of the detergent application. Such detergent application allows fine-tuned interactions of detergent with dye or milk, enabling distinct patterns to emerge based on specific design requirements. For example, the ability to adjust the deposition rate enables the detergent to be introduced at an optimal speed, preventing sudden disruptions in the dye pattern that could result from an uncontrolled application. The amount of detergent released is also carefully regulated to avoid excessive mixing, which could dilute the visual impact of the artwork. The detergent-dispensing mechanism 112 further allows positioning of detergent droplets, permitting targeted application at various points on the milk surface based on design input. Additionally, detergent-dispensing mechanism 112 provides flexibility in the pattern of detergent application, including options such as droplet-based dispensing, jet sprays and surface touch-down. Further, each dispensing mode has unique effects on the interaction with the dye. For example, a jet spray can create broader, diffused patterns, while droplet dispensing allows for concentrated areas of interaction that produce more defined shapes. Moreover, a surface touch-down technique enables the detergent to contact specific areas without dispersing, creating localized effects that can be particularly effective in generating detailed or textured visuals. Such flexibility in detergent application provides the system 100 the capability to accommodate a wide range of artistic styles and pattern complexities. Moreover, the detergent-dispensing mechanism 112 also maintains the detergent at a controlled temperature to further refine the interaction with the milk composition. The temperature also regulates the behavior of the detergent on the surface of the milk. For example, a cooler detergent can produce a slower, more controlled reaction with the dye, resulting in gentler gradients or transitions, whereas a warmer detergent may interact more dynamically, creating rapid dispersal and bolder patterns. The detergent-dispensing mechanism 112 enables creation of diverse artistic effects that would be difficult to achieve manually by enabling temperature regulation. Additionally, the detergent-dispensing mechanism 112 controls location of detergent application relative to the deposited color to control generation of intrinsic pattern. The application of the detergent to a non-colored area over the milk surface allows the color to flow into the treated area, creating softer, gradient-like effects that contrast with the sharper patterns formed by direct application. The system 100 enables intricate designs that combine sharp details with soft transitions by offering precise control over where the detergent interacts with the color, providing an effect that manual methods cannot consistently replicate. Thus, the detergent-dispensing mechanism 112 provides consistent, complex patterns on the milk surface through controlled application, overcoming the limitations of conventional solutions, which are subjected to human error and variability.

The detergent used in the detergent-dispensing mechanism 112 may be a mild dishwashing detergent containing surfactants such as sodium lauryl sulfate or alkylbenzene sulfonate. The surfactants reduce surface tension, enabling dynamic pattern formation as the detergent interacts with milk fat and protein. Further, low concentration (around 1-2%) typically achieves optimal fluid interactions without overpowering the dye dispersion. Also, other detergents such as laundry or industrial detergents can also be employed, though higher concentrations or stronger surfactants may cause excessive dispersion, disrupting fine details in the artwork.

Additionally, the system 100 comprises an automated transfer mechanism 114 configured to position a photo paper sheet 116 onto the milk composition in a controlled manner to transfer the created intrinsic color pattern onto a skin of the photo paper sheet 116 to create the artwork. The automated transfer mechanism 114 comprises a robotic arm or guided rail system equipped with suction grips or clamps, ensuring precise handling and placement of the photo paper sheet 116. Such careful control minimizes disturbances to the delicate pattern on the surface of the milk composition during transfer. The photo paper sheet 116, typically a high-gloss or matte photo paper, quickly absorbs the food-grade dyes, preserving intricacies of the transferred pattern without smudging. The controlled pressure and alignment provided by the automated transfer mechanism 114 enhance fidelity of the pattern transfer, ensuring the final artwork accurately reflects the design envisioned in the digital design input. The positioning of the photo paper sheet 116 onto the milk surface is critical to accurately transfer the created intrinsic color pattern from the milk surface onto the photo paper sheet without distortion or disruption. The automated transfer mechanism 114 minimizes surface disturbance of the milk composition by carefully controlling the placement of the photo paper sheet 116, thereby preserving the integrity of the intricate color patterns formed by the dye and detergent interactions. It will be appreciated that in traditional methods, manual placement or inadequate control mechanisms often lead to vibrations or irregular movements that disturb the milk surface, causing unwanted smearing or distortion of the color pattern. Such disturbances can occur as the photo paper sheet is lowered, where even minor shifts or vibrations can introduce defects, blurring the finer created intrinsic colour pattern. The automated transfer mechanism 114 reduces vibration-induced defects, preserving the clarity and detail of the intrinsic color pattern. Moreover, the automated transfer mechanism 114 enables that the photo paper sheet 116 to be applied with a controlled deposition, preventing the photo paper sheet 116 from sinking into the milk. The controlled deposition allows the photo paper sheet 116 to make sufficient contact with the milk surface to capture the color pattern while avoiding excessive immersion that could disrupt the artwork. Moreover, after the pattern has been transferred, careful removal of the photo paper sheet 116 is equally important because if the photo paper sheet 116 is not removed correctly, there is a risk of color or milk flowing over the skin of photo paper sheet 116, disturbing or smearing the artwork. The automated transfer mechanism 114 overcomes color or milk flowing over photo paper sheet 116 and disturbing or smearing the artwork by retracting the photo paper sheet 116 in a direction orthogonal to the milk surface, preserving the precision and detail of the transferred artwork. The automated transfer mechanism 114 enables automation of both the placement and removal, providing higher level of consistency and precision that would be challenging to achieve by hand, effectively eliminating the need for repeated attempts or adjustments due to minor disturbances. Thus, the automated transfer mechanism 114 enhances operational efficiency and also enables system 100 for applications where high-quality reproductions are needed, such as commercial art production or design prototyping.

For example, in a practical application, a user may upload a digital design comprising swirling floral patterns into the processing unit 102. The temperature-controlled platform 104 maintains the milk composition at 25° C., ensuring optimal behavior of the food-grade dyes by stabilizing the surface tension and viscosity of the milk composition. The revolving turret mechanism 108, following instructions from the processing unit 102, positions a dispensing nozzle 110 containing turmeric-based yellow dye over the milk container 106 and deposits controlled droplets. Such precise droplet control allows the system 100 to create detailed floral designs. The detergent-dispensing mechanism 112 follows with a jet of biodegradable dish detergent, causing the yellow dye to spread into intricate, organic shapes, dynamically enhancing the pattern complexity. The automated transfer mechanism 114 then places the photo paper sheet 116 onto the surface of the milk composition, transferring the vibrant floral design onto the photo paper sheet 116 with high accuracy and detail preservation.

In an embodiment, photo paper sheet 116 comprises multiple functional layers to enable the absorption and fixation of inks and supports the transfer of an intrinsic color pattern, as described in the present disclosure. The photo paper sheet 116 can comprise a polyethylene coating that provides a waterproof base and supports the ink-receptive layers. The ink-receptive layers include microporous or swellable polymers, often silica-based or alumina-based compounds, that absorb and retain the ink. Additionally, polyvinyl alcohol (PVA) can be used as a common polymer binder within the ink-receptive layers to enhance adhesion and durability of the ink onto the surface of the photo paper sheet 116.

In another embodiment, the photo paper sheet 116 may further comprise optical brightening agents (OBAs), such as fluorescent compounds like stilbene derivatives, enhances the brightness and whiteness of the photo paper sheet 116, thereby improving the clarity and vibrancy of the transferred artwork. In another embodiment, the surface coatings of the photo paper sheet 116 may include resins or gloss coatings that enable the photo paper sheet 116 to exhibit various finishes, such as matte, semi-gloss, or glossy, depending on the requirements of the artwork. Such finishes enables that the photo paper sheet 116 maintains aesthetic appeal while also being functional for the transfer of intricate colour patterns as described in the present disclosure.

In an exemplary embodiment, detergent used in the present system corresponds to Dawn® dish detergent, which comprises sodium lauryl sulfate and sodium laureth sulfate as primary surfactants, which enable effective interaction with the milk composition by reducing surface tension and promoting uniform dispersion of the detergent within the medium. Further, detergent cab comprise viscosity adjusters such as sodium chloride and pH adjusters like sodium hydroxide to maintain stability and operational effectiveness. Additionally, stabilizing solvents, such as alcohol denat., phenoxyethanol, and propylene glycol can be used to effectiveness of detergent to interact with milk. Furthermore, detergent may also comprise additional color imparting agent such as Blue 1, Yellow 5, and Red 33, and to provide a secondary visual profile. The detergent interacts with the milk composition to create chemical reactions that contribute to the formation of intrinsic colour patterns. The effectiveness of the detergent in supporting such reactions improves the overall performance by enabling clear and vivid pattern creation. Additionally, the controlled dispensing of the detergent by the detergent-dispensing mechanism enables the precision of colour patterns formed on the surface of the milk composition.

In another embodiment, food-grade dye used in the present system include McCormick Assorted Food Colors & Egg Dye, comprising red, yellow, and blue dyes. The red dye includes FD&C Red 40 and FD&C Red 3, the yellow dye includes FD&C Yellow 5 and FD&C Red 40, and the blue dye includes FD&C Blue 1 and FD&C Red 40. These dyes can be suspended in a water-based medium with propylene glycol as a solvent and stabilizer, optionally propylparaben as a preservative. The food colours can create intricate designs by interacting with the milk's proteins and fat content. The vibrant hues and stability of the food-grade dyes enable clear pattern visibility and resistance to bleeding or smudging during subsequent transfer onto the photo paper sheet 116. The compatibility of these dyes with the milk composition enables es uniform dispersion and adherence, improving the quality of the transferred artwork.

In another operating example, a user inputs a geometric pattern through the processing unit 102. The temperature-controlled platform 104 keeps the milk composition at a cooler 20° C. to slow the spread of the food-grade dyes, enabling sharper pattern edges. The revolving turret mechanism 108 dispenses alternating droplets of synthetic Blue No. 1 and FD&C Red No. 40 in precisely calculated sequences. Optionally, the detergent-dispensing mechanism 112 introduces a swab-based applicator (described in detail herein later) to selectively disrupt areas of the food-grade dye, creating sharp, defined edges between the colors. The automated transfer mechanism 114 positions the photo paper sheet 116, capturing the crisp, geometric artwork with high fidelity. Such precise interaction between controlled dye deposition, detergent application and automated transfer ensures production of artwork with high aesthetic and technical quality.

In an embodiment, the system 100 comprises a biaxial arm operatively connected to the processing unit 102 to move the revolving turret mechanism 108 over the milk container 106. The biaxial arm, controlled by the processing unit 102, positions each required dispensing nozzle 110 at specified coordinates based on the digital design input. The biaxial arm comprises a dual-axis motorized system, providing precise movement along both the horizontal and vertical planes. The dual-axis control ensures that the revolving turret mechanism 108 can accurately target specific areas of the milk composition for dye deposition, which is crucial for creating intricate and complex designs. The precision of the biaxial arm allows seamless transitions between different sections of the artwork, reducing misalignment and improving overall quality of the pattern. The use of robust materials such as aluminum or reinforced plastic minimizes flex during operation, maintaining consistent accuracy and reliability even under continuous use. Such precision enhances the capability of the system 100 to produce high-resolution, detailed artwork, significantly expanding the range of possible design intricacies.

In another embodiment, each dispensing nozzle 110 of the revolving turret mechanism 108 comprises a variable droplet dispenser configured to adjust both droplet size and pattern of the food-grade dye deposited onto the surface of the milk composition. The variable droplet dispenser achieves such precision through an adjustable aperture mechanism, which changes the size of the nozzle opening and a pressure-regulating system controlling the flow of dye. The varying of the droplet size enables the system 100 to create a wide range of effects from fine gradients to bold strokes, adding depth and texture to the artwork. The ability to modify droplet pattern allows for the creation of layered and textured effects, enabling production of more visually complex and engaging designs. Such flexibility enhances artistic versatility of the system 100, allowing customization of the output to meet specific design needs. The precise control over droplet size and pattern also minimizes dye wastage, improving operational efficiency and reducing material costs. The precise control mechanism enables the system 100 to achieve highly detailed patterns with clear distinctions between colors and shapes, enhancing visual impact and fidelity of the final artwork.

In yet another embodiment, the detergent-dispensing mechanism 112 comprises a selectable applicator for depositing detergent onto the milk composition. The selectable applicator can be chosen from options such as a jet spray, a droplet dispenser or a swab-based applicator, depending on the desired effect on the dye pattern. The jet spray applicator delivers a fine mist of detergent, creating broad, soft dispersal of the dye, ideal for generating smooth gradients or subtle blending effects. The droplet dispenser applies detergent in precise, localized amounts, creating sharp and well-defined disruptions in the dye, enabling formation of intricate and detailed pattern variations. The swab-based applicator allows for direct manipulation of specific areas of the milk composition, enabling highly controlled and deliberate artistic adjustments. Such flexibility in detergent application enhances the creative potential of the system 100, allowing a diverse range of visual styles and effects. The ability to switch between applicators quickly and efficiently improves workflow, enabling faster transitions between different artistic techniques. The aforesaid capabilities contribute to the overall versatility of the system 100, enabling production of a wide variety of artistic outputs, from fluid and organic designs to sharply defined geometric patterns, catering to different artistic preferences and project requirements.

In an embodiment, the system 100 further comprises an agitation arm operatively connected to the processing unit 102 and configured to interact with selected portions of the milk composition. The agitation arm comprises a soft-tip actuator designed to manipulate the surface of the milk composition gently. The agitation arm performs localized stirring or controlled disruptions to refine or alter specific areas of the dye pattern. The soft-tip actuator, typically made from silicone or a similarly soft, non-reactive material, ensures that the milk composition is disturbed without damaging the overall pattern. Such targeted agitation enables precise, real-time adjustments to the dye dispersion, allowing for the creation of complex patterns such as ripples or waves. The capability adds unique textural elements to the artwork, enhancing artistic depth and complexity. The agitation arm enables interactive pattern modification, thereby significantly expanding the creative flexibility of the system 100 and allowing users to achieve personalized artistic effects with high precision.

In another embodiment, the automated transfer mechanism 114 is configured to perform a surface modification or skin modification of the photo paper sheet 116 prior to positioning the photo paper sheet onto the milk composition. The surface modification may involve processes such as pre-heating, applying a thin adhesive layer or lightly embossing the skin to enhance dye adhesion and pattern clarity. The pre-heating enables the photo paper sheet 116 reaches optimal temperature conditions for immediate absorption of the dye upon contact, preventing delays in dye setting and reducing smudging. The application of the adhesive layer or a chemical coating enhances dye fixation, enabling that the transferred pattern remains sharp and vibrant over time. The embossing method can create a slight texture on the photo paper sheet 116, adding depth and a three-dimensional quality to the final image. Such surface modifications significantly improve the adhesion of the dye to the skin, enhancing the clarity, durability and overall visual quality of the artwork.

In yet another embodiment, the system 100 comprises a drying station configured to receive the photo paper sheet 116 after the transfer of the created intrinsic color pattern. The drying station may incorporate a combination of airflow, heat or UV light to set the dye rapidly and securely on the photo paper sheet 116. The controlled drying process efficiently removes moisture while preventing warping or distortion of the photo paper sheet 116. The drying station accelerates the drying process, reducing the risk of smudging or damage during handling and ensuring the artwork is quickly stabilized and ready for further use or display. Precise control over drying conditions preserves the sharpness and vibrancy of the transferred patterns, enhancing the longevity and professional appearance of the artwork. Such an operation of the system 100 ensures that the final product maintains aesthetic integrity and durability over time.

In an embodiment, the system 100 further comprises a light source positioned adjacent to the milk container 106 to selectively dry specific portions of the artwork transferred onto the photo paper sheet 116. The light source is selected from a UV emitter or an infrared (IR) emitter, depending on the desired drying effect. The UV emitter quickly sets the dye by curing the dye through photopolymerization, preserving fine details and enhancing sharpness of the artwork. Alternatively, the IR emitter provides uniform heat distribution, gently drying the photo paper sheet 116 without causing warping or color distortion. The selective drying capability allows precise control over which parts of the artwork are dried first, enabling staged drying for complex patterns and reducing the risk of smudging. Such controlled drying process enhances clarity, precision and durability of the final artwork, ensuring intricate designs are accurately preserved and maintaining overall visual quality.

In another embodiment, the system 100 comprises a feedback unit comprising a high-resolution camera configured to monitor the evolution of the artwork on the milk composition in real time. The feedback unit captures detailed images of the pattern formation and relays this data to the processing unit 102. The real-time monitoring allows the system 100 to make immediate adjustments to dye deposition, detergent application or agitation based on observed changes in the pattern. The high-resolution camera ensures precise detection of even subtle variations, enabling the system 100 to maintain a high level of accuracy throughout the process. Such a continuous feedback loop improves pattern consistency and allows for adaptive corrections, ensuring the final artwork closely matches the original digital design input. The ability to monitor and adjust in real time significantly reduces errors, enhances precision, and ensures high-quality output.

In yet another embodiment, the system 100 comprises a vibration mechanism configured to impart controlled vibratory motion to the milk container 106. The vibration mechanism gently agitates the milk composition, producing minor dispersion of the deposited food-grade dyes without disrupting the overall artwork pattern. The controlled vibratory motion enhances the natural flow of the dyes, creating subtle variations and dynamic textures within the pattern. The vibration mechanism can be precisely adjusted in terms of frequency and amplitude, allowing for tailored artistic effects such as gentle wave-like motions or fine dispersion enhancements. The aforesaid feature adds depth and complexity to the artwork, providing a more visually engaging and textured final product. The controlled agitation ensures that these effects are introduced uniformly, improving artistic quality and aesthetic appeal of the resulting design.

In an embodiment, the system 100 further comprises a tilting mechanism configured to apply a controlled tilt to the milk container 106. The tilting mechanism is operatively connected to the processing unit 102 and enables adjustment of the angle of the milk container 106, directing the flow of the deposited food-grade dye and detergent across the surface of the milk composition. The tilting mechanism precisely controls the tilt angle, allowing the system 100 to create directional patterns such as cascades or gradients. The motorized actuator in the tilting mechanism ensures fine angular adjustments, enhancing the dynamic aspect of pattern formation. Such capability allows for complex, flowing designs that are difficult to achieve manually, improving automation and reducing user intervention. The controlled tilting not only ensures consistent and reproducible results but also broadens the range of artistic effects achievable, enhancing both the efficiency and creative flexibility of the system 100.

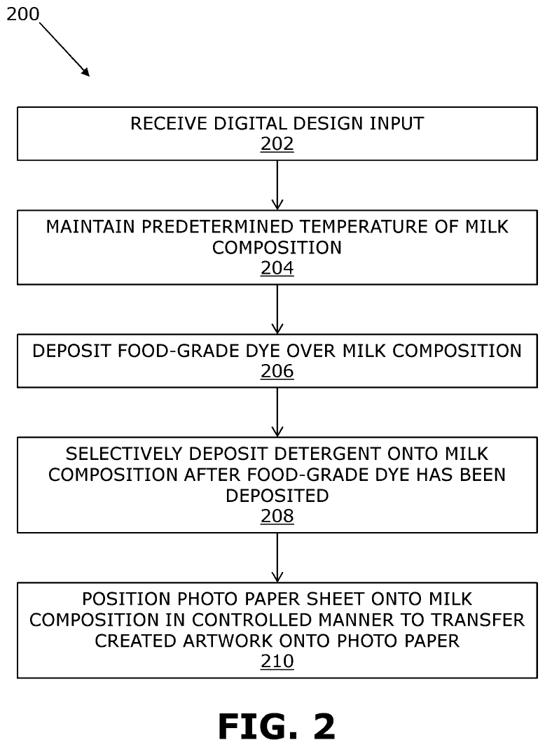

Referring to FIG. 2, there is shown a flowchart 200 illustrating steps 202-210 of a method for automated creation of an artwork, in accordance with an embodiment of the present disclosure. At a step 202, a digital design input is received via a processing unit. At a step 204, a predetermined temperature of a milk composition is maintained within a temperature-controlled platform comprising a milk container to hold the milk composition. At a step 206, a revolving turret mechanism is rotated to select and position a dispensing nozzle corresponding to a food-grade dye over the milk composition to deposit at least one food-grade dye based on the digital design input. At a step 208, at least one detergent is selectively deposited onto the milk composition after the at least one food-grade dye has been deposited to enable interaction of the detergent with the dye to create the artwork. At a step 210, a photo paper sheet is positioned onto the milk composition in a controlled manner using an automated transfer mechanism to transfer the created artwork onto the photo paper.

Throughout the present disclosure, non-limiting examples of the milk composition are animal-based milk—cow milk, goat milk, sheep milk, buffalo milk, camel milk, yak milk, donkey milk; plant-based milk—almond milk, soy milk, oat milk, rice milk, coconut milk, cashew milk, hemp milk, pea milk, macadamia milk, flax milk, walnut milk, hazelnut milk, pistachio milk, quinoa milk; specialty/flavored milk—chocolate milk, strawberry milk, vanilla milk, banana milk, matcha milk, turmeric milk (golden milk), cinnamon milk, rose milk; lactose-free and enhanced milk—lactose-free milk, A2 milk, fortified milk, high-protein milk, calcium-enriched milk; fermented and cultured milk—kefir, buttermilk, yakult, laban, acidophilus milk; powdered and condensed milk—evaporated milk, condensed milk, powdered milk; non-traditional and niche varieties—barley milk, spelt milk, tigernut milk, pumpkin seed milk, sesame milk, sunflower seed milk.

Referring to FIG. 2, there is shown a flowchart 200 illustrating steps 202-210 of a method for automated creation of an artwork, in accordance with an embodiment of the present disclosure. At step 202, a digital design input is received via a processing unit, initiating the process by translating the design into actionable commands for the system components. Such precise control reduces manual intervention and enhances the accuracy of pattern reproduction. At step 204, a milk composition is maintained at a predetermined temperature within a temperature-controlled platform, ensuring consistent physical properties such as viscosity and surface tension. Such stability is crucial for predictable dye behavior and detergent interaction, leading to uniform and reproducible pattern formation.

At step 206, a revolving turret mechanism is rotated to select and position a dispensing nozzle corresponding to a food-grade dye over the milk composition. The step facilitates precise dye deposition, directly enhancing the detail and intricacy of the created patterns. Further, accurate placement of dyes ensures complex designs are faithfully reproduced from the digital input. At step 208, at least one detergent is selectively deposited onto the milk composition to interact with the dye, enabling the creation of dynamic and intricate patterns. The controlled interaction between the detergent and dye introduces fluidity and variation, allowing for complex textures and visual effects. Finally, at step 210, a photo paper sheet is positioned onto the milk composition in a controlled manner using an automated transfer mechanism. Such a process ensures high-fidelity transfer of the artwork, preserving the integrity and detail of the original pattern, resulting in a visually precise and durable final artwork.

In an embodiment, following step 208, the method comprises adjusting the agitation of the milk composition to further refine the dye pattern before the photo paper sheet is positioned. Such controlled agitation allows for subtle modifications of the pattern, enabling the creation of intricate textures and dynamic effects that enhance the visual complexity of the artwork. The precise control over agitation ensures that the pattern remains consistent and visually appealing, contributing to the overall quality of the final artwork.

In another embodiment, the method comprises performing a pre-treatment on the photo paper sheet before the sheet is positioned onto the milk composition at step 210. The pre-treatment may involve heating the photo paper sheet or applying a thin layer of adhesive to enhance dye absorption and ensure better adhesion of the transferred pattern. Such a step improves the clarity and durability of the transferred artwork, resulting in a sharper and more vibrant final image with enhanced longevity.

In yet another embodiment, following step 210, the method comprises drying the photo paper sheet after the artwork has been transferred. The drying process involves controlled application of heat or UV light to set the dye quickly, preventing smudging and ensuring the artwork remains intact. Such a step stabilizes the pattern, preserving the detail and vibrancy of the transferred artwork, while also ensuring that the photo paper sheet is ready for handling or display immediately after the process.

In an embodiment, the method comprises applying a protective coating over the transferred artwork on the photo paper sheet to enhance durability and resistance to environmental factors. The protective coating may include polymer-based materials, such as acrylic or polyurethane compounds, applied as a thin film over the artwork. Optionally, the protective coating may be applied using a spray mechanism, a roller, or a dipping process. The application of the protective coating enables that the transferred artwork remains resistant to external elements such as moisture, UV light, and mechanical abrasion. Such an application contributes to the longevity and preservation of the artwork.

In another embodiment, the method comprises heating the milk composition to a predetermined temperature prior to dye deposition to optimise the reaction between the milk composition and the detergent. The temperature-controlled platform maintains the milk composition within a range that enables effective protein interaction with the detergent and dye, enable clear and vibrant pattern formation. Optionally, the temperature may be dynamically adjusted based on the type of milk composition or specific requirements of the artwork. The controlled heating improves the reaction kinetics, thereby enhancing the quality and uniformity of the patterns formed.

In yet another embodiment, the method comprises adjusting the pressure applied during the transfer process of the photo paper sheet onto the milk composition to control the depth of pattern imprints on the photo paper sheet. The automated transfer mechanism may incorporate sensors and actuators to regulate the pressure during the transfer step. Optionally, the pressure adjustments may be based on the type of photo paper sheet or the desired artistic effect. Such pressure control enable accurate and consistent transfer of the artwork, preventing smudging or distortion of the patterns.

In an embodiment, the method comprises positioning the photo paper sheet at a specific angle relative to the milk composition using the automated transfer mechanism to control the pattern geometry. The automated transfer mechanism incorporates an adjustable positioning system, such as a servo-motor-based arm or a gimbal mount, to enable precise angular adjustments. The angle may be varied within a predetermined range, depending on the design requirements of the artwork, to influence the spatial distribution of the intrinsic colour patterns transferred onto the photo paper sheet. Optionally, the angular positioning may be preprogrammed based on the digital design input or dynamically adjusted during the transfer process to refine the geometry of the patterns. The specific angle enable controlled transfer of the artwork, preventing undesired smudging or misalignment while achieving intricate design features. Such angular control contributes to enhanced artistic flexibility and improved precision in the resulting artwork.

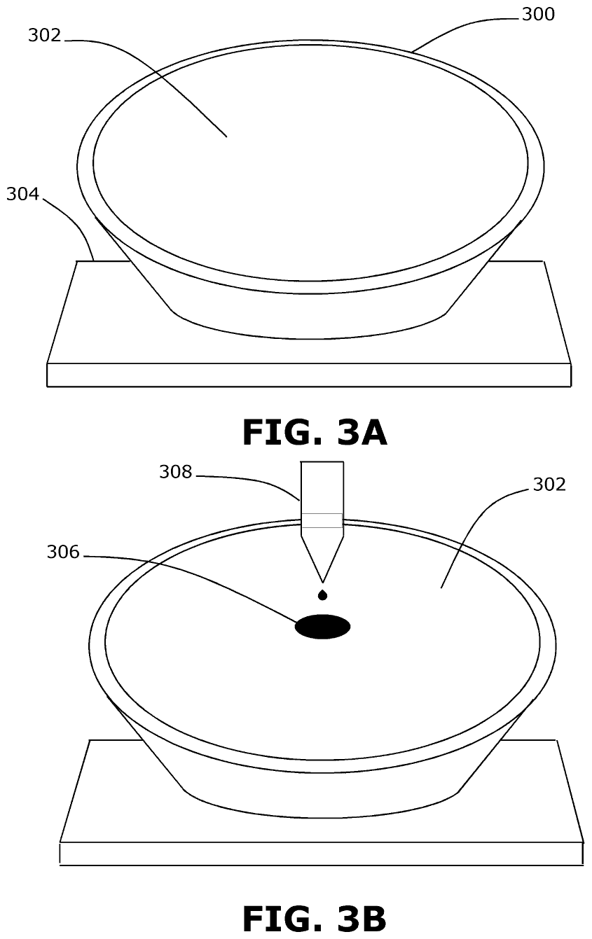

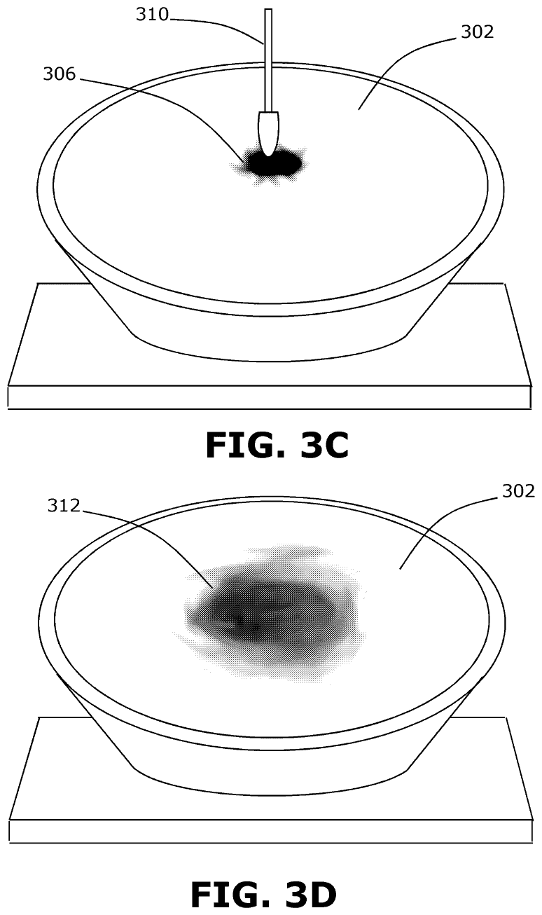

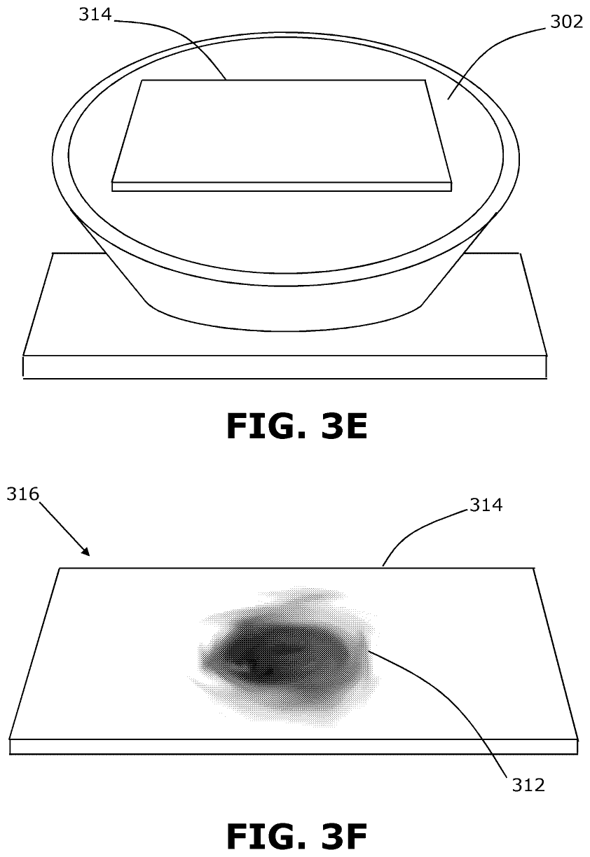

Referring to FIGS. 3A-F, there are shown steps of creating an artwork 316 using the method for automated creation of the artwork 316, in accordance with an embodiment of the present disclosure. As shown in FIG. 3A, a milk container 300 (such as the milk container 106 of FIG. 1) containing a specific milk composition 302 is received on platform 304 (such as the platform 104 of FIG. 1).

Referring to FIG. 3B, the food-grade dyes 306 deposited onto the milk surface include McCormick Assorted Food Colors. Such dyes are water-based and contain components such as FD&C Red 40 and Blue 1, as well as stabilizers like propylene glycol and propylparaben, which ensure consistent dispersion and interaction with the milk protein. The dyes create vivid and stable patterns that are effectively captured during the transfer process. Referring to FIG. 3C, the detergent used in the detergent-dispensing mechanism 310 includes components such as sodium lauryl sulfate and alkyl dimethylamine oxide, which act as surfactants. Such compounds reduce the surface tension of the milk, enabling the formation of fluid color patterns. The colorants and fragrances in the detergent, including blue and yellow hues, further contribute to the aesthetic of the process, while the controlled application ensures precision and repeatability. Referring to FIG. 3D, during the formation of the intrinsic color pattern (312), a chemical reaction occurs between the milk protein and specific components of the other materials used in the process. The protein in the milk interacts with food-grade dyes such as McCormick Assorted Food Colors, Dawn Dish Detergent and the surface coatings of the Inkjet Photo Paper. Such an interaction facilitates the dispersion of colors on the milk surface and stabilizes the patterns formed. For example, the surfactants in the detergent reduce the surface tension of the milk, enabling dynamic color dispersion, while the optical brightening agents in the photo paper enhance the vibrancy of the transferred artwork. In FIG. 3E, a photo paper sheet 314 is placed onto the intrinsic color pattern 312 formed on the surface of the milk composition 302. Referring to FIG. 3F, the photo paper 314 used for transferring the artwork has been optimized for high-quality pattern reproduction. The photo paper 314 includes a polyethylene coating for water resistance, ink-receptive layers comprising silica-based polymers to hold the dyes effectively and optical brightening agents that enhance the clarity and vibrancy of the transferred patterns. The choice of paper finish, such as glossy or matte, influences the final appearance and texture of the artwork.

In an embodiment, the processing unit 102 utilizes artificial intelligence or machine learning-based techniques to analyze the digital design input to determine optimal operational parameters for temperature-controlled platform 104, revolving turret mechanism 108, dispensing nozzle 110, detergent-dispensing mechanism 112 and automated transfer mechanism 114. For example, through trained AI models that account for past design data, viscosity measurements and environmental conditions, the processing unit 102 may identify that maintaining the milk composition at 18° C. will yield ideal viscosity for a specific gradient effect. In contrast, for designs requiring fine, intricate lines, the processing unit 102 may reduce the platform temperature to around 14° C. to thicken the milk, ensuring that dye dispersal remains confined to designated areas. The processing unit 102 determines specific temperature requirements based on factors such as milk viscosity, desired dye flow characteristics, and interaction with detergent.

Similarly, the processing unit 102 determines the rotational speed, sequence and position of dispensing nozzle 110 by controlling the revolving turret mechanism 108. The processing unit 102 selects specific dispensing nozzles 110 based on the digital input, such that each nozzle is loaded with a different food-grade dye. Subsequently, the processing unit 102 positions each nozzle at precise coordinates above the milk surface to deposit dye at the required position. For example, for a design with a complex color pattern featuring layered hues, the processing unit 102 may set the rotation speed of turret mechanism 108 to 30 RPM to position each nozzle within a tolerance of 0.5 mm over the target area, for accurate color placement and minimal bleed between colors. Further, the processing unit 102 calculates the sequence in which each dispensing nozzle 110 must be activated, optimizing for smooth transitions and layered effects without color bleeding or overlapping.

Moreover, the processing unit 102 dynamically regulates each dispensing nozzle 110 to adjust parameters such as droplet size, flow rate and nozzle angle. For example, a design requiring fine, detailed lines will prompt the processing unit 102 to reduce droplet size and minimize flow rate, allowing the required dye application to achieve the desired line thickness. Similarly, for detailed sections, the system 100 may restrict droplet size to 0.1 ml at a flow rate of 0.5 ml/sec. In contrast, when covering large areas, the system 100 can increase droplet size to 1 ml with a flow rate of 2 ml/sec, significantly speeding up coverage while maintaining uniform color intensity. Such dynamic adjustment allows the dispensing nozzle 110 to produce both delicate and bold visual elements.

Moreover, the processing unit 102 determines the type, amount and placement of detergent necessary to create specific visual effects, regulating detergent-dispensing mechanism 112 accordingly. For designs that require color diffusion or blending effects, the processing unit 102 controls detergent-dispensing mechanism 112 to enable application of detergent to target sections of the milk composition. For example, in cases where a subtle gradient is needed, the processing unit 102 may direct the application of detergent at 0.2 ml per second to regions near dye deposits, allowing for controlled diffusion without overspreading. Similarly, more complex designs may involve concentrations of 0.1 ml in certain areas and up to 0.5 ml in others, facilitating intricate blending effects. In such complex designs, the processing unit 102 regulates detergent-dispensing mechanism 112 to apply detergent at varying concentrations across different areas.

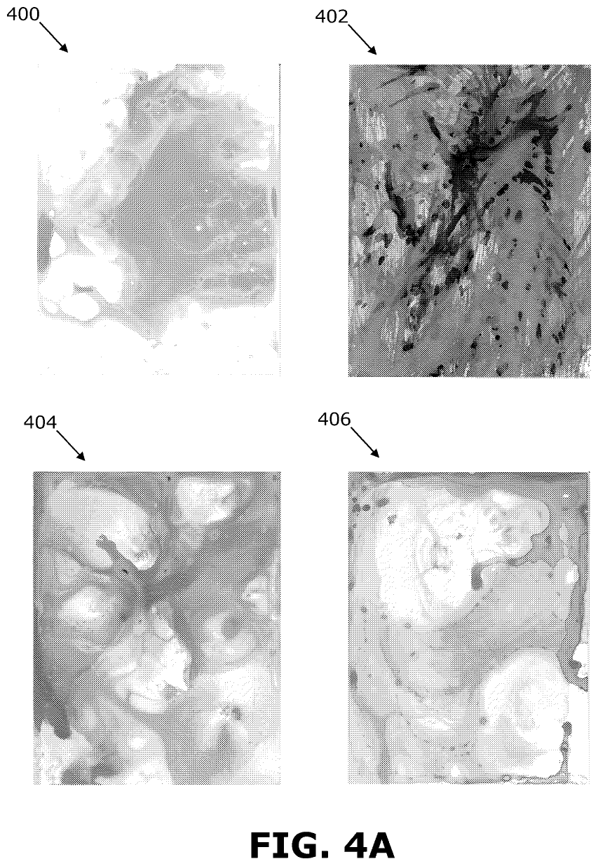

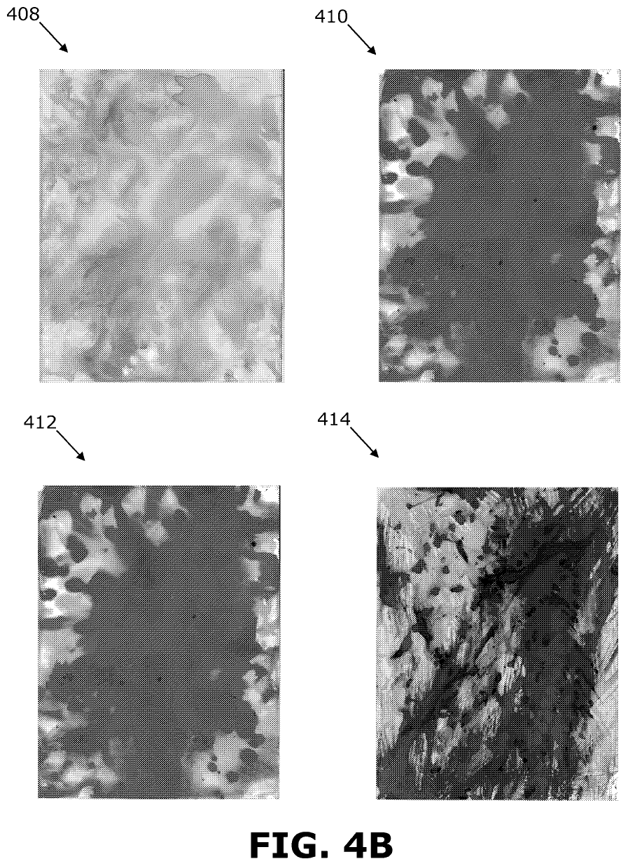

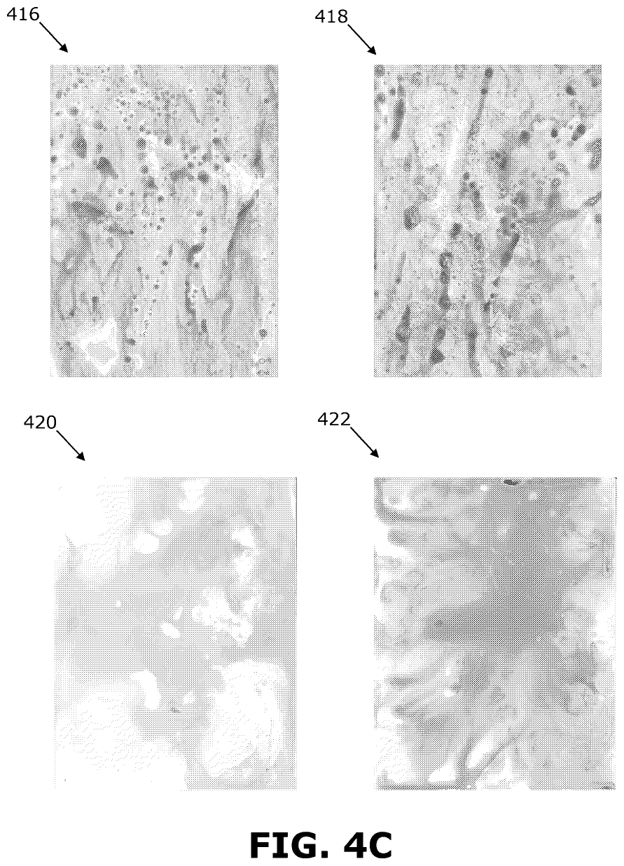

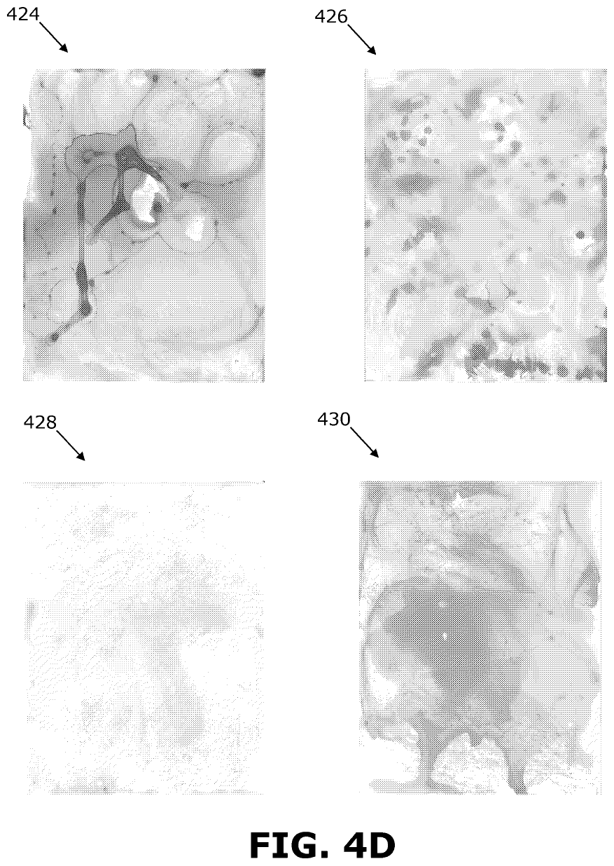

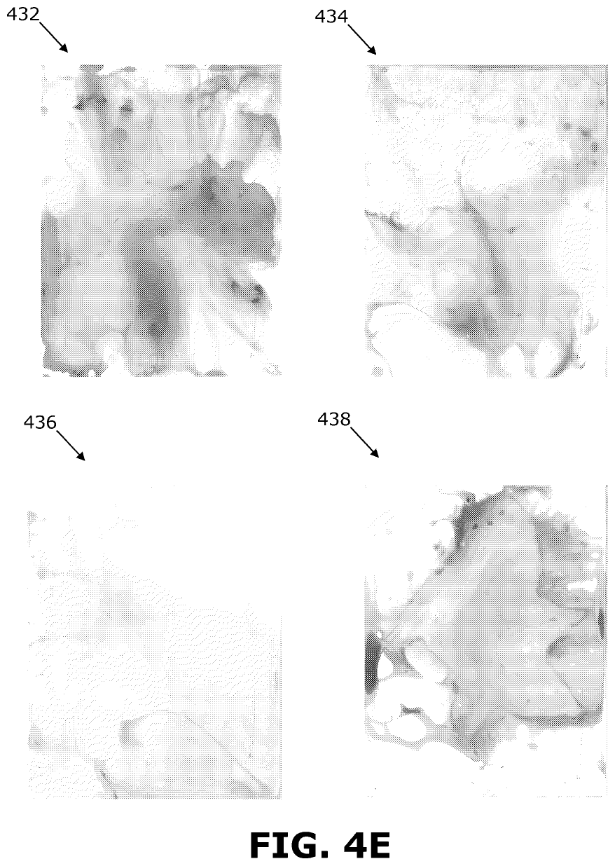

Referring to FIGS. 4A-F, there are shown artworks 400-444 created using a system for automated creation of an artwork (such as the system 100 of FIG. 1), in accordance with an embodiment of the present disclosure.

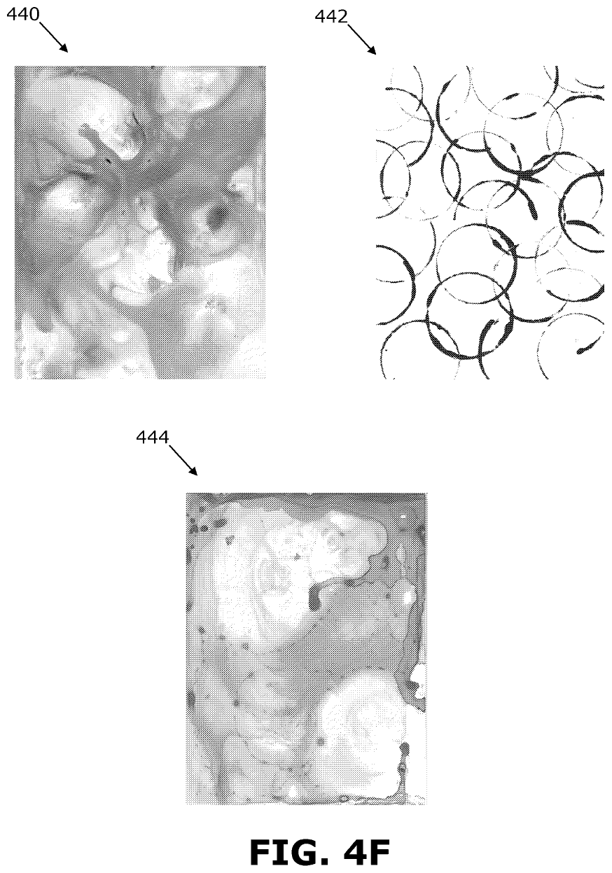

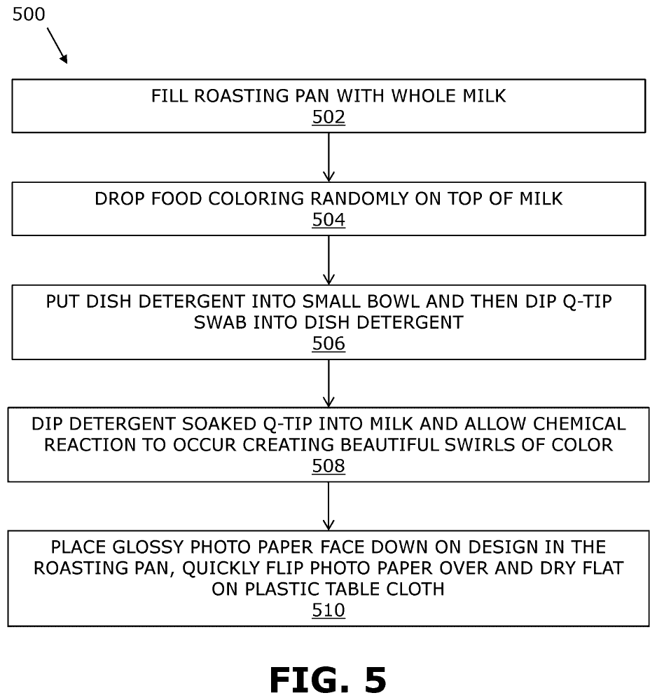

Referring to FIG. 5, there is shown a diagram 500 illustrating steps of manually creating an artwork using a method for automated creation of the artwork, in accordance with an embodiment of the present disclosure. At step 502 relating to ‘conception and initiation’, a roasting pan is filled with milk (such as whole milk). At step 504 relating to ‘definition and planning’, food coloring (such as McCormick food coloring) is randomly dropped on top of the milk. At step 506 relating to ‘launch or execution’, dish detergent (such as Dawn Blue dish detergent) is taken and put into a small bowl. Subsequently, a Q-tip swab is dipped into the dish detergent. At step 508 relating to ‘performance and control’, the Dawn-soaked Q-tip swab is dipped into the milk and chemical reaction is allowed to occur, creating beautiful swirls of color. At step 510 relating to ‘project closing’, glossy photo paper is placed face down on the design in the roasting pan. Then, the photo paper is quickly flipped over and dried flat on a plastic table cloth.

It will be appreciated that various components of the system may be permanently or temporarily (such as, detachably) coupled to each other using various permanent or temporary means, including but not limited to, welding the components together, using screws, nuts, bolts and the like to join the components together, attaching the components using magnets and the like. Such details are commonly available in the art and have therefore been omitted throughout the Detailed Description and the appended Claims for the sake of conciseness.

It will also be appreciated that modifications, additions, or omissions may be made to the systems and apparatuses described hereinafter without departing from the scope of the Claims. The components of the systems and apparatuses may be integrated or separated. Moreover, the operations of the systems and apparatuses may be performed by more, fewer, or other components.

1. A system for automated creation of an artwork, the system comprising:
a processing unit configured to receive a digital design input;
a temperature-controlled platform comprising a milk container to hold a milk composition, wherein the platform maintains the milk composition at a predetermined temperature;
a revolving turret mechanism comprising a plurality of dispensing nozzles, wherein each dispensing nozzle corresponds to a different food-grade dye, and wherein the revolving turret mechanism is configured to rotate, to position a required dispensing nozzle, over the milk container to deposit at least one food-grade dye onto the milk composition based on the received digital design input;
a detergent-dispensing mechanism configured to selectively deposit at least one detergent onto the milk composition after the at least one food-grade dye is deposited, to create an intrinsic color pattern on a surface of the milk composition; and
an automated transfer mechanism configured to position a photo paper sheet onto the milk composition in a controlled manner to transfer of the created intrinsic color pattern onto a skin of the photo paper to create the artwork.

2. The system as claimed in claim 1, wherein the system comprises a biaxial arm operatively connected to the processing unit to move the revolving turret mechanism over the milk container, and wherein the biaxial arm is controlled by the processing unit to position each required dispensing nozzle at the specified coordinates based on the digital design input.

3. The system as claimed in claim 1, wherein each dispensing nozzle of comprises a variable droplet dispenser configured to adjust both a droplet size and a pattern of the food-grade dye deposited onto the surface of the milk composition.

4. The system as claimed in claim 1, wherein the detergent-dispensing mechanism comprises a selectable applicator for depositing the detergent onto the milk composition, and wherein the selectable applicator is selected from: a jet spray, a droplet dispenser and a swab-based applicator.

5. The system as claimed in claim 1, further comprising an agitation arm operatively connected to the processing unit and configured to interact with the selected portions of the milk composition, wherein the agitation arm comprises a soft-tip actuator configured to modify the created intrinsic color pattern.

6. The system as claimed in claim 1, wherein the automated transfer mechanism is configured to perform a surface modification of the photo paper sheet prior to positioning the sheet onto the milk composition.

7. The system as claimed in claim 1, further comprising a drying station configured to receive the photo paper sheet after transfer of the created intrinsic color pattern.

8. The system as claimed in claim 1, further comprising a light source positioned adjacent to the milk container to selectively dry the specific portions of the artwork transferred onto the photo paper sheet, and wherein the light source is selected from: an ultraviolet (UV) emitter or an infrared (IR) emitter.

9. The system as claimed in claim 1, further comprising a feedback unit comprising a high-resolution camera configured to monitor an evolution of the artwork on the milk composition, and wherein the feedback unit communicates real-time data to the processing unit for the real-time adjustments in the deposition of the at least one food-grade dye and the at least one detergent.

10. The system as claimed in claim 1, further comprising a vibration mechanism configured to impart controlled vibratory motion to the milk composition to produce minor dispersion of the deposited at least one food-grade dye without disrupting the artwork pattern.

11. The system as claimed in claim 1, further comprising a tilting mechanism configured to apply a controlled tilt to the milk container to adjust an angle of the milk composition, thereby directing flow of the deposited at least one food-grade dye and the at least one detergent.

12. A method for automated creation of an artwork, the method comprising:
receiving a digital design input via a processing unit;
maintaining a predetermined temperature of a milk composition within a temperature-controlled platform comprising a milk container to hold the milk composition;
rotating a revolving turret mechanism to select and position a dispensing nozzle corresponding to a food-grade dye over the milk composition to deposit at least one food-grade dye based on the digital design input;
selectively depositing at least one detergent onto the milk composition after the at least one food-grade dye is deposited to enable interaction of the detergent with the dye to create the artwork; and
positioning a sheet of photo paper onto the milk composition in a controlled manner using an automated transfer mechanism to transfer the created artwork onto the sheet.

13. The method as claimed in claim 12, further comprising adjusting the transferred pattern on the photo paper sheet before drying.

14. The method as claimed in claim 12, further comprising drying the photo paper sheet after transferring the intrinsic color pattern.

15. The method as claimed in claim 12, further comprising scanning the photo paper sheet to generate a digital version of the artwork.

16. The method as claimed in claim 12, further comprising applying a protective coating over the transferred artwork on the photo paper sheet to enhance durability and resistance to environmental factors.

17. The method as claimed in claim 12, further comprising heating the milk composition to a predetermined temperature prior to dye deposition to optimize the reaction between the milk composition and the detergent.

18. The method as claimed in claim 12, wherein the automated transfer mechanism positions the photo paper sheet at a specific angle relative to the milk composition to control the pattern geometry.

19. The method as claimed in claim 12, wherein the step of positioning the photo paper sheet further comprises adjusting the pressure applied during the transfer process to control the depth of pattern imprints on the photo paper sheet.
